(19) United States
(12) Patent Application Publication
(10) Pub. No.: US 2002/0155341 A1
(43) Pub. Date: Oct. 24, 2002

(54) Self-managing electrochemical fuel cell and fuel cell anode

(75) Inventors: Gennadi Finkelshtain, Givatada (IL); Yuri Katsman, Hadera (IL); Boris Filanovsky, Jerusalem (IL); Alex Osherov, Beer Sheva (IL); Leonid Titelman, Yehud (IL)

Correspondence Address: DR. MARK FRIEDMAN LTD., c/o ANTHONY CASTORINA, SUITE 207, 2001 JEFFERSON DAVIS HIGHWAY, ARLINGTON, VA, 22202, US

(73) Assignee: More Energy LTD.

(21) Appl. No.: 09/837,278

(22) Filed: Apr. 19, 2001

(51) Int. Cl. H01M 4/94; H01M 4/90; H01M 4/96; H01M 8/10; H01M 8/08; H01M 4/92

(52) U.S. Cl. 429/44; 429/42; 429/30; 429/46

(57) ABSTRACT

A fuel cell is provided that is suited for mobile and portable applications. Using an innovative anode with a layer to control the rate of diffusion of fuel to the fuel cell anode, fuel crossover through the liquid or solid electrolyte of the fuel cell is prevented Electrolyte integrity is preserved, giving a more robust and reliable fuel cell. Further, the innovative anode allows for the use of highly active fuel compositions which otherwise may be chemically oxidized, releasing heat, or give unstable electrical currents. The use of active fuel compositions with the anode, as well as a fuel composition and liquid electrolyte in which gaseous side-products dissolve allows for the design of robust, powerful portable fuel cell which can be used at room temperature with little peripheral equipment.

### FIELD AND BACKGROUND OF THE INVENTION

The present invention relates to electrochemical fuel cells and to an electrode for use in electrochemical fuel cells.

A fuel cell is a device that converts the energy of a chemical reaction into electricity. Amongst the advantages that fuel cells have over other sources of electrical energy are high efficiency and environmental friendliness. Although fuel cells are increasingly gaining acceptance as electrical power sources, there are technical difficulties that prevent the widespread use of fuel cells in many applications, especially mobile and portable applications.

A fuel cell produces electricity by bringing a fuel and an oxidant in contact with a catalytic anode and catalytic cathode, respectively. When in contact with the anode, the fuel is catalytically oxidized on the catalyst, producing electrons and ions. The electrons travel from the anode to the cathode through an electrical circuit connecting the electrodes. The ions pass through an electrolyte with which both the anode and the cathode are in contact. Simultaneously, the oxidant is catalytically reduced at the cathode, consuming the electrons and the ions generated at the anode.

The common type of fuel cell uses hydrogen as a fuel and oxygen as an oxidant. Specifically, hydrogen is oxidized at the anode, releasing protons and electrons as shown in equation 1:

H₂→2H⁺+2e⁻ (1)

The protons pass through an electrolyte towards the cathode. The electrons travel from the anode, through an electrical load, to the cathode. At the cathode, the oxygen is reduced, combining with electrons and protons produced from the hydrogen to form water as shown in equation 2:

½O₂+2H⁺+2e⁻→H₂O (2)

Although fuel cells using hydrogen as a fuel are simple, clean and efficient the extreme flammability and the bulky high-pressure tanks necessary for storage and transport of hydrogen mean that hydrogen powered fuel cells are inappropriate for many applications.

In general, the storage, handling and transport of liquids is simpler than of gases. Thus liquid fuels have been proposed for use in fuel cells. Methods have been developed for converting liquid fuels such as methanol into hydrogen, in situ. These methods are not simple, requiring a fuel pre-processing stage and a complex fuel regulation system.

Fuel cells that directly oxidize liquid fuels are the solution for this problem. Since the fuel is directly fed into the fuel cells, direct liquid-feed fuel cells are comparatively simple. Most commonly, methanol is used as the fuel in these type of cells, as it is cheap, available from diverse sources and has a high specific energy (5020 Ahl⁻¹).

A typical direct methanol-feed fuel cell 10 is schematically depicted in FIG. 1 Fuel contained in a chamber 12 is in contact with a catalytic anode 14. Catalytic anode 14 is in contact with an electrolyte 16 that is in contact with cathode 18 Cathode 18 is in contact with oxygen in air 20 Anode 14 and cathode 18 are also electrically connected through circuit 22. Electrolyte 16 can be solid or liquid.

In fuel cell 10, oxygen is reduced at cathode 18 as in equation 2 while methanol is catalytically oxidized at anode 14, equation 3:

CH₃OH→CO+4H⁺+4e⁻ (3)

Carbon monoxide tightly bonds so the catalytic sites on anode 14. The number of available sites for further oxidation is reduced, reducing power output.

A solution to this problem is to supply a fuel composition into fuel chamber 12 as an “anolyte”, a mixture of a fuel, usually an alcohol such as methanol, with an aqueous electrolytic liquid. In the case where the fuel is methanol, and if the anolyte and electrolyte 16 are acidic or neutral, then the fuel reacts with water at anode 14 to produce carbon dioxide and hydrogen ions, equation 4:

CH₃OH+H₂O→6H⁺+CO₂+6e⁻ (4)

while oxygen 20 is reduced at cathode 18 as in equation 2.

If the anolyte and electrolyte 16 are basic, the fuel reacts with hydroxide ions at anode 14 to produce carbon dioxide, water and electrons, equation 5:

CH₃OH+6OH⁺→CO₂+5H₂O+6e⁻ (5)

while at cathode 18 oxygen 20 is reduced and combines with water to produce hydroxide ions, equation 6:

O₂+2H₂O−4c⁻→4OH⁺ (6)

In fuel cells with liquid electrolytes there exists the problem of methanol crossover. Methanol from fuel chamber 12 diffuses through anode 14 and accumulates in electrolyte 16. If fuel comes in contact with cathode 18, a “short-circuit” occurs as the fuel is oxidized directly on cathode 18, generating heat instead of electricity. Furthermore, depending upon the nature of the cathode catalyst, catalyst poisoning or sintering often occurs

For various reasons, basic liquid anolytes have lost popularity over the years. Acidic anolytes are often used. Unfortunately, the fuel cell must be operated at elevated temperatures at which the acidity of the anolyte can passivate or destroy the anode. Anolytes with a pH close to 7 are anode-friendly, but have an electrical conductivity that is too low for efficient electricity generation. Consequently, most direct methanol-feed fuel cells known in the art use solid polymer electrolyte (SPE) membranes.

In a fuel cell using SPE membranes, the general construction is as depicted in FIG. 1, but that electrolyte 16 is a proton exchange membrane that acts both as an electrolyte and as a physical barrier preventing leakage from fuel chamber 12 wherein the anolyte is contained. One membrane often used as a solid fuel-cell electrolyte is a perfluorocarbon material sold by E. I. DuPont de Nemours of Wilmington Del. under the trademark “Nafion”. Although these membranes are expensive and not robust, SPE membrane fuel cells have superior performance to other fuel cell designs.

A practical disadvantage of SPE membrane fuel cells arises from the tendency of high concentrations of methanol to dissolve the membrane and to diffuse through it. As a result, a significant proportion of methanol supplied to the cell is not utilized for generation of electricity but is lost through evaporation. Once the methanol passes the membrane, a short-circuit, as described hereinabove, can occur.

The problem of membrane penetration is overcome by using anolytes with a low (up to 3%) methanol content. The low methanol content limits the efficiency of the fuel cell when measured in terms of electrical output as a function of volume of fuel consumed and raises issues of fuel transportation, dead weight and waste disposal. Further limiting the use of direct methanol-feed fuel cells, especially for mobile and portable applications, is the expense and complexity of necessary peripheral equipment for fuel circulation, replenishment heating and degassing. A typical direct methanol-feed fuel cell equipped with a solid electrolyte 11 is depicted in FIG. 2. An anolyte with 3% methanol is contained in a fuel chamber 12 and in contact with a catalytic anode 14. Catalytic anode 14 is in contact with proton exchange membrane 16 that is in contact with cathode 18 Cathode 18 is in contact with oxygen in air 20. Anode 14 and cathode 18 are also electrically connected through circuit 22. Pump 24 causes the anolyte to pass through a degasser 26, a cleaner 28, a mixer 30, and a heater 32 Gaseous side-products such as CO₂ escape through vent 34. Mixer 30 continuously replenishes the methanol in the anolyte by adding methanol from vessel 36.

Mobile and especially portable direct liquid-feed fuel cells are much desired. However the fuel cells described above are generally not robust, do not have a sufficient power output, and as seen from FIG. 2, require so much peripheral equipment that they quickly become complex and bulky.

As mentioned above, one limitation of fuel cells known in the art is that the methanol is rather unreactive at room temperature limiting the power output of fuel cells and requiring fuel heating. In U.S. patent application 09/752,551 a highly active fuel composition is disclosed which is suitable for use in direct liquid-feed fuel cells at room temperature. The fuel composition disclosed in U.S. patent application 09/752,551 combines a liquid fuel such as methanol and hydrogen-containing inorganic compounds such as NaBH₄ to produce high currents at low temperatures. However, due to its reactivity this fuel composition has an increased tendency to undergo chemical oxidation on contact with catalyst, producing heat and gas. This tends to an unstable current and may lead to destruction of the catalyst. Under certain conditions the fuel composition may even undergo chemical oxidation when the electrical circuit is open.

There is a need for a direct liquid-feed fuel cell that is suitable for mobile and portable use. Such a fuel cell should have a high energy content per unit volume of fuel, should be mechanically simple with few components, and should be robust Furthermore, there is a need for a way to reduce or prevent fuel crossover in direct liquid-feed fuel cells with either liquid or solid electrolytes. There is a need for a way to stabilize the current of high active fuel composition in fuel cell.

### SUMMARY OF THE INVENTION

The above and other objectives are achieved by the use of the innovative electrode and the innovative fuel cell provided by the present invention.

The electrode of the present invention is made up of at least two layers, a catalytic layer and diffusion control layer in contact with said catalytic layer. The electrode can also have a second diffusion control layer in contact with the catalytic layer, so that the catalytic layer is sandwiched between the two diffusion control layers.

According to a feature of the present invention, the catalytic layer contains platinum, often with added ruthenium, nickel, cobalt, tin or molybdenum. The catalytic layer is preferable made to catalyze oxidation reactions, that is, the electrode is designed to serve as an anode.

According to a feature of the present invention, the catalytic layer is attached to a conductive substrate. The conductive substrate can be, for example a nickel or gold mesh, or a non-conductive substrate (such as a ceramic material) coated with a conductive material.

According to a feature of the present invention, the diffusion control layer is made of carbon paper, fiber fleece or a microporous film. The carbon paper may be modified to increase hydrophilicity, for example by impregnating it with polyvinyl alcohol.

The invention further provides a fuel cell for the generation of electrical power, made up of a fuel composition, a cathode, and an anode as described above, that is, the anode has at least at diffusion control layer and a catalytic layer, so that the fuel composition must pass through the diffusion control layer to arrive at the catalytic layer.

According to a further feature of the present invention, the fuel cell also has an electrolyte to transport ions from the anode to the cathode. The electrolyte may be solid, such as a proton exchange membrane, or the electrolyte may be a liquid, a gel or a suspension. According to a further feature of the present invention the exhaust gases produced in the fuel cell are substantially soluble in the electrolyte.

According to a further feature of the present invention, the electrolyte has a pH above about 7, for example an aqueous solution of an alkali metal hydroxide such as KOH or NaOH with a concentration of around between 3 M and about 12 M, preferable around 6 M.

According to a further feature of the present invention, the fuel composition i made of a fuel and an electrolyte, known in the are as an anolyte. The electrolyte may have a pH above about 7, for example, an aqueous solution of an alkali metal hydroxide such as KOH or NaOH with a concentration of around between 3 M and about 12 M, preferable around 6 M. According to a further feature of the present invention, the exhaust gases produced in the fuel cell are substantially soluble in the fuel composition. According to further feature of the present invention, the fuel in the fuel composition includes an alcohol for example methanol. According to a still further feature of the present invention, there is a viscosity-controlling component in the fuel composition. Such a viscosity-controlling component can be, for example, glycerine, ethylene glycol or polyethylene glycol.

According to a further feature of the present invention the diffusion control layer is configured to allow diffusion of the fuel composition to the catalytic layer at a rate which is less than the rate of oxidation of the fuel at the catalytic layer.

According to a still further feature of the present invention there is provided a value mechanism that blocks and unblocks the flow of fuel to the anode.

There is also provided according to the teachings of the present invention a method to regulate power output of the fuel cell be adjusting the viscosity of the fuel composition and the permeability of a layer through which the fuel composition must diffuse to make contact with the anode in order to regulate the rate of diffusion of the fuel to the anode.

### BRIEF DESCRIPTION OF DRAWINGS

The invention is herein described, by way of example only, with reference to the accompanying drawings, where:

FIG. 1 (prior art) is a schematic depiction of a direct liquid-feed fuel cell.

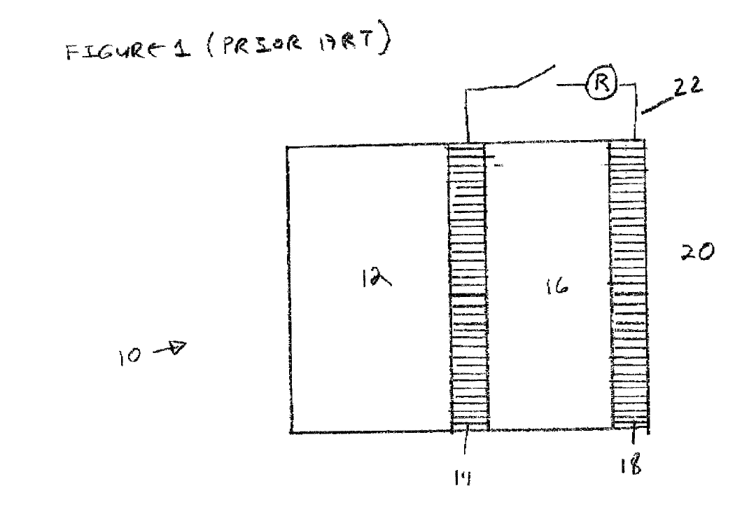

FIG. 2 (prior art) is a schematic depiction of a direct liquid-feed fuel cell with a proton exchange membrane electrolyte;

FIG. 3 is a first embodiment of the anode of the invention with one diffusion control layer;

FIG. 4 is a second embodiment of the anode of the invention with two diffusion control layers;

FIG. 5 is a first embodiment of the fuel cell of the invention with a polymer electrolyte membrane;

FIG. 6 is a second embodiment of the fuel cell of the invention with liquid electrolyte; and

FIGS. 7A and 7B depict a planar valve useful for preventing contact between anolyte and a fuel cell anode.

### DESCRIPTION OF THE PREFERRED EMBODIMENTS

The principles and operation of the anode and the fuel cell of the present invention may be better understood with reference to the figures and accompanying description.

First, it is necessary to understand the relationship between the rate of diffusion and the stability of the current produced when using a highly active fuel composition, for example as described in U.S. patent application 09/752,551 by considering two cases:

when

V_{diffusion}>V_{electrochemical} (7)

and when

V_{diffusion}<V_{electrochemical} (8)

where

V_{diffusion} is the rate of diffusion of fuel to the anode; and

V_{electrochemical} is the rate of electrochemical oxidation of the fuel at the anode.

In equation 7 the rate of diffusion is higher than the rate of electrochemical oxidation of the fuel. All catalytic sites are occupied and in the immediate vicinity of every catalytic site there are many other fuel molecules. Once a fuel molecule has been oxidized the produced ions and electrons are immediately transported away, but the gaseous side-products require a finite time to be removed. This often happens non-monotonously as a gas bubble is formed and is suddenly released from the catalytic surface. Current instability results.

In equation 8 the rate of diffusion is similar to or lower than the rate of electrochemical oxidation of the fuel V_{electrochemical} is dependent on the number of catalytic sites. When V_{diffusion}<V_{electrochemical} there are always catalytic sites free which are immediately available to catalyze the electrochemical oxidation of the fuel. There is a sufficient delay between the arrival of two fuel molecules at any given catalytic center for molecules of gaseous side-products to clear away. As is clear to one skilled in the art this leads to production of a stable current.

In addition, it is necessary to remember that a fuel molecule at a catalytic site can undergo two reactions: the desired electrochemical oxidation and the undesired chemical oxidation. The chemical oxidation reaction has a higher energetic barrier and is therefore significantly slower then the electrochemical oxidation. It has been observed that when a high concentration of certain highly active fuel molecules is present in the vicinity of a catalyst, chemical oxidation may occur. When not wishing to be held to any theory, it is believed that standard catalysts may have sites that selectively catalyze only the chemical oxidation reaction. If a sufficiently active fuel molecule is present in the vicinity of the catalyst and no electrochemical reaction catalyzing site is available, there may be sufficient time for the chemical oxidation to occur despite the comparatively high energetic barrier.

As methanol is relatively unreactive at room temperature and is ordinarily supplied only in low concentrations, chemical oxidation is not a serious problem. However, with more active fuel compositions this can lead to inefficient fuel use and an exorbitant release of heat.

The anode of the present invention overcomes the problem of current instability and competing chemical oxidation by controlling the rate of diffusion of fuel molecules to the catalytic centers. The anode of the present invention consists of at least two layers. The first layer is a catalytic layer and the second is a diffusion control layer. The catalytic layer acts in a substantially usual way, presenting the catalytic centers that allow electrochemical fuel oxidation.

The diffusion control layer separates the fuel composition from the catalytic layer. The primary function of the diffusion control layer is to limit the rate of arrival of fuel molecules at the catalytic layer. The diffusion control layer ensures that the rate of production of electricity by the fuel cell is diffusion-controlled and constant, without interference due to side-products and side-reactions.

the anode is further configured to allow ions and electrons produced to be transported to the cathode ordinarily through an electrolyte and through an electric circuit, respectively.

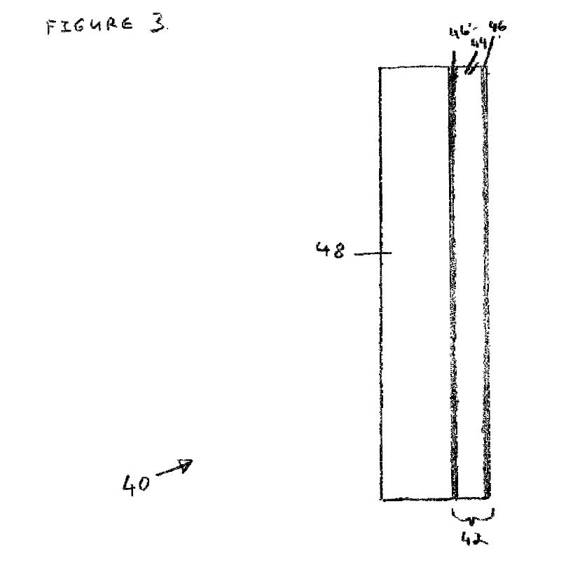

In the first embodiment of the present invention 40, depicted in FIG. 3, catalytic layer 42 is a made of a conducting substrate 44 onto which a catalyst 46 has been supplied. Conducting substrate 44 can be, for example, nickel or gold mesh, or a nickel-plated or gold-plated perforated ceramic sheet. Catalyst 46 is typically a mixture of metals, for example Pt/Ru, Pt/Ni, Pt/Co, Pt/Sn or Pt/Mo and can be applied to conducting substrate 44 by methods known in the art. Ordinarily catalysts are either provided as pure metals (unsupported catalysts) or provided adsorbed or otherwise connected to a material such as carbon black (supported catalysts). The catalyst, whether supported or unsupported, are in contact with or attached to conducting substrate 44 so that electrons produced at the catalyst are conducted to conducting substrate.

Diffusions control layer 48 is in contact with catalytic layer 42 in such a way that fuel molecules must diffuse through diffusion control layer 48 to make contact with catalytic layer 42. Diffusion control layer 48 is made up of a sheet of carbon paper impregnated with PVA (polyvinyl alcohol). The PVA increases the hydrophilic properties of the carbon paper. Alternatively, a layer of wet-laid fiber fleece (for example, of PVA fibers) or microporous films (such as grafted polypropylene, polysulfone or polycarbonate) can be used. The thickness and other properties of the diffusion control layer are selected to ensure that the rate of diffusion of the fuel is sufficiently low to achieve the desired current properties.

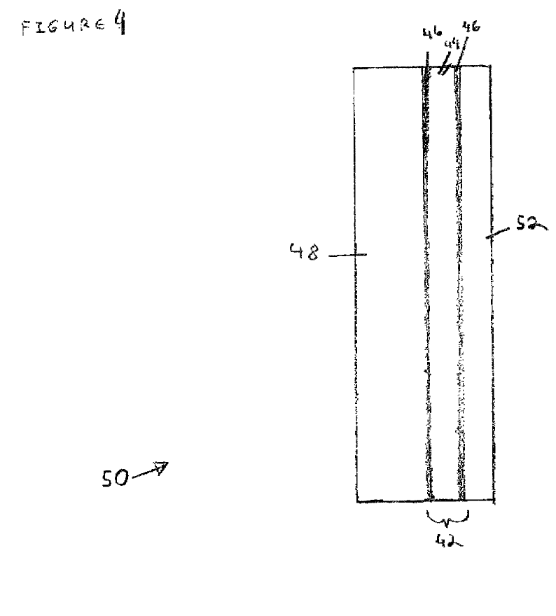

In a second preferred embodiment of an anode 50 of the present invention, depicted in Fig. 4, a catalytic layer 42 as described above is sandwiched between two diffusion control layers 48 and 52. The thickness and other properties of the diffusion control layer 48 that separates catalytic layer 42 from the fuel are so that V_{diffusion}<V_{electrochemical}. The thickness and other properties of diffusion control layer 52 that separates catalytic layer 42 from the electrolyte are so that the rate of diffusion of ions away from the catalytic layer is higher than V_{electrochemical}.

Beyond the regulation of the rate of diffusion, diffusion control layers 48 and 52 in both embodiments above prevent pieces of catalyst 46 from disconnecting from conductive substrate 44 and in particular, from falling into the fuel chamber.

As is clear to one skilled in the art, the catalytic layer and the diffusion control layers must be chemically compatible with the fuel composition and the anolyte components.

Beyond the current-stabilizing properties of the anode of the present invention, the anode can be used to prevent fuel crossover, that is, the passage of fuel through the catalytic layer that may contaminate or otherwise compromise the electrolyte and if arriving at the cathode, short-circuit the fuel cell. Use of the anode of the present invention allows the addition of higher than accepted concentration of fuel in an anolyte or other fuel composition, with the concomitant advantages thereof.

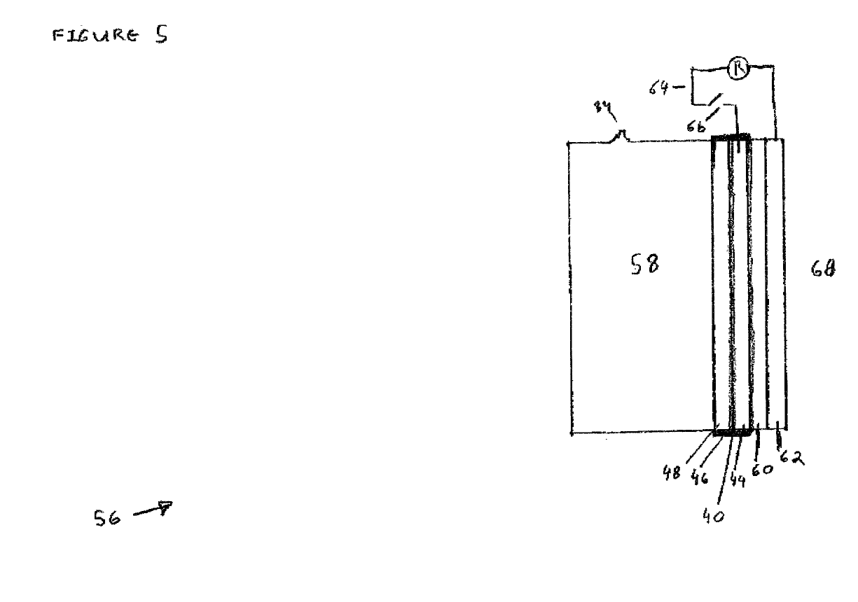

Depicted in FIG. 5, is a first embodiment of fuel cell 56 of the present invention. Fuel cell 56 uses a two-layer anode 40 of the present invention as depicted in FIG. 3 with a diffusion control layer 48, a catalytic layer 46 and a conducting substrate 44. Fuel composition 58 is supplied as an anolyte composed of 40% methanol in an acidic solution (e.g. 0.1% H₂SO₄ in water). Fuel cell 56 uses a proton exchange membrane 60 to transport protons from anode 40 to cathode 62. Circuit 64 electrically connects anode 40 through conducting substrate 44 to cathode 62.

Protons produced by the electrochemical oxidation are transported by proton exchange membrane 60 to cathode 62 Simultaneously, electrons produced are transported to cathode 62 through conducting substrate 44 and circuit 64. Oxidant 68 is oxygen from air and has free contact with cathode 62. Oxidant 68 is reduced on cathode 62 and combines with the protons and electrons to produce water. Released CO₂ escapes through vent 34.

Diffusion control layer 48 limits the availability of methanol molecules at catalytic layer 46. Since the rate of methanol molecules arriving is controlled to be less than the maximal amount that are potentially oxidized any methanol arriving at the anode is electrochemically oxidized before it can make contact with proton exchange membrane 60. Thus, the integrity and lifetime of proton exchange membrane 60 is maintained and fuel cell 56 as a whole is more robust. Since such a cell has a higher concentration of fuel molecules per unit anolyte volume, it is more compact and efficient.

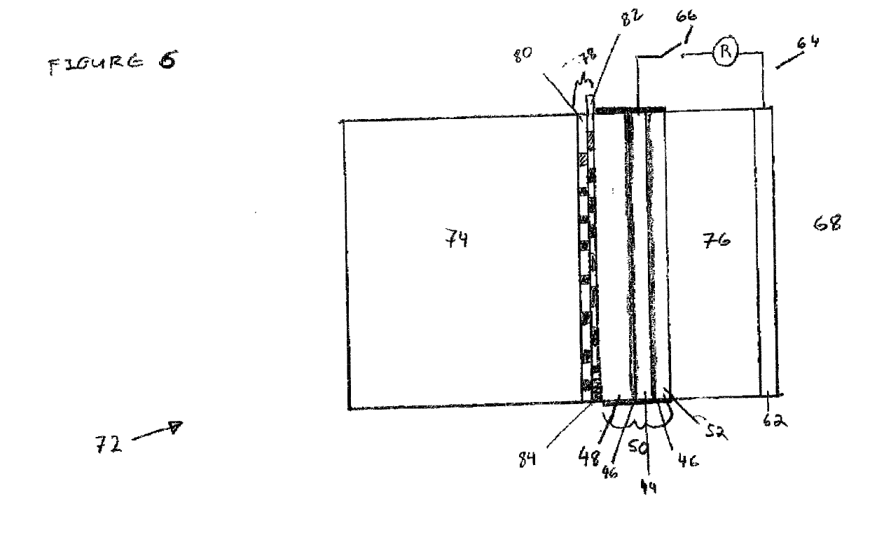

Depicted in FIG. 6, is a second embodiment of a fuel cell of the present invention 72. Fuel cell 72 uses a three-layer anode 50 of the present invention as depicted in FIG. 4 with a first diffusion control layer 48, a catalytic layer 46, a conducting substrate 44 and a second diffusion control layer 52. Fuel composition 74 is supplied as an anolyte composed of 40% methanol in a 6 M KOH solution. A 6M KOH or electrolyte solution is contained within electrolyte chamber 76. The electrolyte solution transports ions from anode 50 to cathode 62. Circuit 64 electrically connects anode 50 through conducting substrate 44 to cathode 62. Since anolyte 58 contains a high concentration of KOH, released CO₂ remains in solution and thus there is no need for venting of produced gases.

The manner of usage and operation of fuel cell 72 in FIG. 6 is, an analogy to fuel cell 56 illustrated in FIG. 5, apparent to one skilled in the art. Accordingly, no further discussion relating to the manner of usage and operation will be provided. It is important to emphasize that the presence of diffusion control layer 48 prevents contamination of electrolyte 76 by methanol, as described hereinabove.

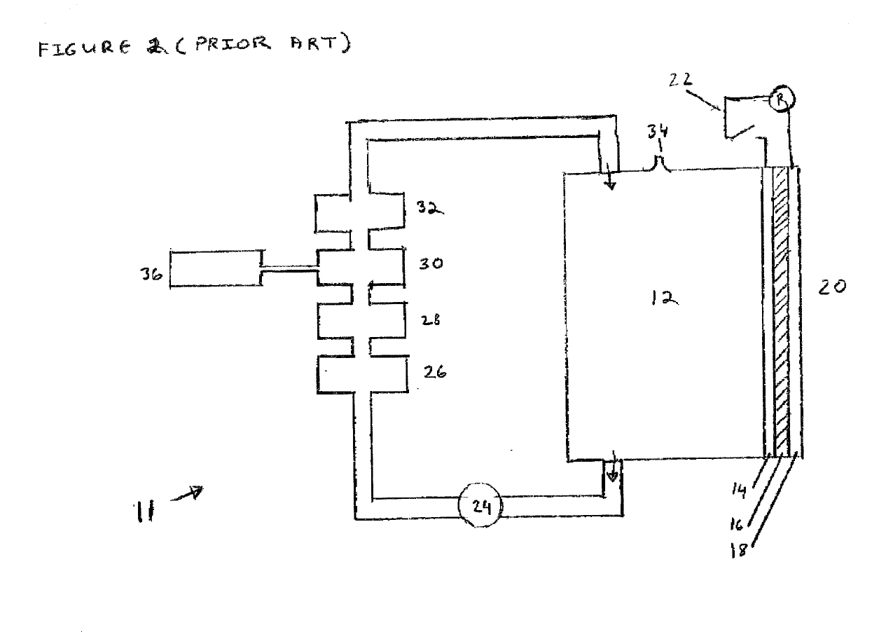

A great advantage of a fuel cell of the present invention of the type depicted in FIG. 6 is that its simplicity of construction relative to a state-of-the-art fuel cell, as depicted in FIG. 2, makes it exceptionally suitable for mobile and portable applications. The use of an anolyte and an electrolyte that solvates the exhaust gases avoids the need for venting and a degassing step. The use of a liquid electrolyte allows a more robust design, removing the need to use an expensive and sensitive PEM membrane.

Exceptionally advantageous is to use a fuel cell of the type exemplified by the fuel cell depicted in FIG. 6 with the highly active fuel composition described in U.S. patent application 09/752,551. The fuel composition allows an exceptionally high power and current density at room temperature for a given volume of anolyte, making a fuel cell using the highly active fuel composition ideal for portable and mobile applications. The high reactivity of the fuel composition obviates the need for fuel heating.

When used with the fuel composition described in U.S. patent application 09/752,551 the anode of the present invention reduces or prevents chemical oxidation and leads to production of a more stable current when compared to a usual anode.

Since the fuel composition described in U.S. patent application 09/752,551 is significantly more reactive than methanol, a situation may arise where there is fear that significant chemical oxidation of the fuel composition may occur when the electrical circuit if open. Thus may be especially problematic when it is necessary to store a charged fuel cell for an extended period of time. It may therefore be advantageous in certain cases to add a value mechanism to the fuel cell of the present invention that forms a physical barrier preventing contact between fuel composition and the diffusion control layer and which is opened when the fuel cell is in use. One ordinarily skilled in the art is well acquainted with the construction and use of suitable value mechanisms.

For the purpose of clarification, a simple planar valve 78 that can be interposed between the chamber where fuel composition 74 is contained and anode 50 is depicted in FIG. 6. Planar valve 78 is made up of a perforated front plate 80 facing fuel 74, a perforated back plate 82 facing anode 50 and a biasing mechanism 84.

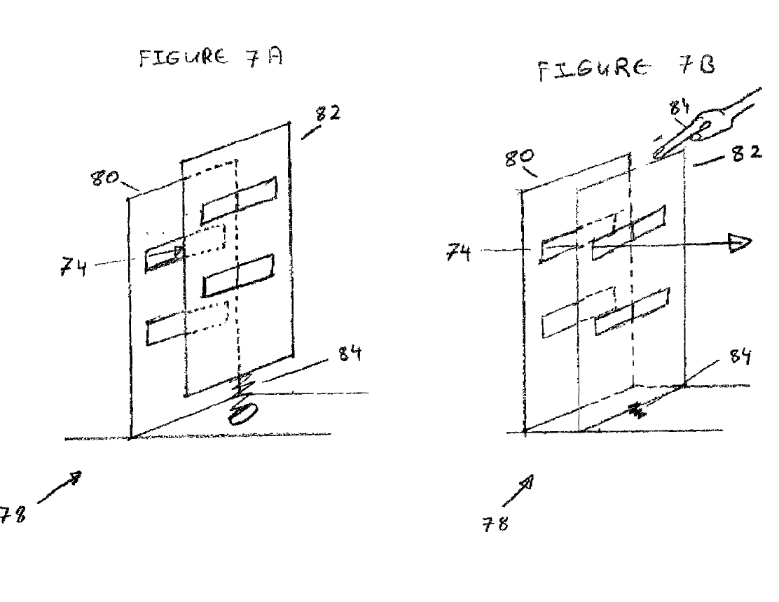

Planar valve 78 is depicted in greater detail in FIGS. 7a and 7b. When the fuel cell is not in use, FIG. 7a biasing mechanism 84 pushes back plate 82 upwards, clocking passage of fuel composition 74 through valve 78. When the fuel cell is in use. FIG 7b , back plate 82 is pushed downwards 84, aligning the respective perforations of front plate 80 and back plate 82, allowing passage of fuel composition 74 through valve 78.

A method supplementary to the use of diffusion control layer for controlling the rate of diffusion of a fuel composition to the catalytic layer of an anode is the addition of a viscous component to the fuel composition. Such a viscous component may be, for example, glycerine or polyethylene glycol. The resulting increased viscosity of the fuel composition lowers the rate of diffusion through a diffusion control layer when this is desired.

The addition of a viscous component is useful in a number of cases. For example, in a situation when a fuel cell containing an anode of the present invention optimized for use in Alaska is used in the Mojave Desert. The addition of a viscous component to the fuel composition compensates for the lowered viscosity of the fuel composition resulting from the increased ambient temperature.

The addition of a viscous component is also useful for reducing current output in order to increase fuel economy. It is clear to one skilled in the art, that when an anode of the present invention is used, the maximal current produced is limited by the rate of diffusion of fuel through the diffusion control layer. If in a specific application less power is needed than the fuel cell is designed to supply, addition of a viscous compound to the fuel composition will lower the power output with no ill effect and lead to a significant saving of fuel. When higher power is again required, the fuel composition containing the viscous compound is washed out and fresh fuel composition is added.

Many other embodiments of the invention can be countenanced. For example, whereas the two embodiments of fuel cells described above use oxygen from air as an oxidant, with the necessary modifications a liquid oxidant can be used, for example, an organic fluid with a high oxygen concentration (see U.S. Pat. No 5,185,218) or a solution of hydrogen peroxide.

Although the description above refers to a fuel cell anode, it is clear to one skilled in the art that there may be instances where it is advantageous to realize the cathode of a fuel cell using the teachings of the present invention, namely to control the rate of arrival of the material to be reduced at the cathode.

While the invention has been described with respect to a limited number of embodiments, it will be appreciated that many variations, modifications and other applications of the invention may be made.

What is claimed is:

1. An electrode, suitable for use in a fuel cell, comprising
a) a catalytic layer, and
b) a diffusion control layer in contact with said catalytic layer.

2 The electrode of claim 1 further comprising a second diffusion control layer in contact with said catalytic layer, so that said catalytic layer is sandwiched between said diffusion control layer and said second diffusion control layer.

3 The electrode of claim 1 wherein said catalytic layer includes platinum.

4 The electrode claim 3 wherein said catalytic layer further includes at least one metal from the group consisting of ruthenium, nickel, cobalt, tin and molybdenum.

5. The electrode of claim 1 wherein said catalytic layer is configured to catalyze oxidation reactions.

6. The electrode of claim 1 wherein said catalytic layer is attached to a conductive substrate.

7. The electrode of claim 6 wherein said conductive substrate is a conductive mesh

8 The electrode of claim 6 wherein said conductive substrate of made of one of the group consisting of nickel, gold, and a non-conductive substrate coated with a conductive material.

9 The electrode of claim 1 wherein said diffusion control layer is made of carbon paper.

10. The electrode of claim 9 wherein said carbon paper is modified to increase hydrophilicity.

11. The electrode of claim 10 wherein said modification includes impregnation with polyvinyl alcohol.

12. The electrode of claim 1 wherein said diffusion control layer is made of fiber fleece.

13. The electrode of claim 1 wherein said diffusion control layer is a microporous film.

14 A fuel cell for the generation of electrical power, comprising
a) a fuel composition contained within a fuel chamber;
b) an anode having a catalytic layer and a diffusion control layer, said diffusion control layer interposed between said fuel chamber and said catalytic layer and in contact with said catalytic layer; and
c) a cathode.

15. The fuel cell of claim 14 further comprising an electrolyte configured to transportation from said anode to said cathode.

16. The fuel cell of claim 15 wherein said electrolyte is solid.

17. The fuel cell of claim 16 wherein said electrolyte is a proton exchange membrane.

18. The fuel cell of claim 15 where said electrolyte is selected from the group consisting of a liquid, a gel and a suspension.

19. The fuel cell of claim 18 wherein said electrolyte has a pH above about 7.

20. The fuel cell of claim 19 wherein said electrolyte is substantially an aqueous solution of an alkali metal hydroxide.

21. The fuel cell of claim 20 wherein said alkali metal hydroxide is selected from the group consisting of KOH and NaOH.

22 The fuel cell of claim 20 wherein said electrolyte has an alkali metal hydroxide concentration of between about 3 M and about 12 M.

23. The fuel cell of claim 22 wherein said concentration is substantially 6 M.

24. The fuel cell of claim 18 wherein exhaust gases produced in the fuel cell are substantially soluble in said electrolyte

25. The fuel cell of claim 14 wherein said fuel composition comprises a fuel and an electrolyte

26 The fuel cell of claim 25 wherein said electrolyte has a pH above about 7.

27. The fuel cell of claim 26 wherein said electrolyte is substantially an aqueous solution of an alkali metal hydroxide.

28. The fuel cell of claim 27 wherein said alkali metal hydroxide is selected from the group consisting of KOH and NaOH.

29. The fuel cell of claim 28 wherein said electrolyte has an alkali metal hydroxide concentration of between about 3 M and about 12 M.

30. The fuel cell of claim 29 wherein said concentration is substantially 6 M

31. The fuel cell of claim 24 wherein said fuel includes an alcohol.

32. The fuel cell of claim 31 wherein said alcohol is methanol.

33. The fuel cell of claim 24 wherein said fuel composition further comprises a viscosity-controlling component.

34. The fuel cell of claim 33 wherein said viscosity-controlling component includes at least one compound from the group consisting of glycerine, ethylene glycol and polyethylene glycol.

35 The fuel of cell 14 wherein said diffusion control layer is configured to allow diffusion of said fuel composition from said fuel chamber through said diffusion control layer to said catalytic layer at a rate less than a rate of oxidation of said fuel at said catalytic layer.

36. The fuel cell of claim 14 further comprising a valve mechanism configured so as to selectively block and unblock flow of said fuel from said fuel chamber to said anode.

37. The fuel cell of claim 14 wherein exhaust gases produced in the fuel cell are substantially soluble in said fuel composition.

38. A method to regulate power output of a fuel cell with an anode comprising:
a) providing a fuel with a viscosity;
b) providing a layer with a permeability through which said fuel must diffuse to make contact with the anode; and
c) adjusting said viscosity and said permeability to regulate a rate of diffusion of said fuel to the anode.
